(19) United States
(12) Patent Application Publication
(10) Pub. No.: US 2019/0202177 A1
(43) Pub. Date: Jul. 4, 2019

(54) COMPOSITE PANE FOR A HEAD-UP DISPLAY

(71) Applicant: SAINT-GOBAIN GLASS FRANCE, Courbevoie (FR)

(72) Inventors: Florian MANZ, Aachen (DE); Uwe VAN DER MEULEN, Nideggen (DE); Valentin SCHULZ, Niederzier (DE)

(21) Appl. No.: 16/329,024

(22) PCT Filed: Jul. 25, 2017
(86) PCT No.: PCT/EP2017/068708

§ 371 Date: Feb. 27, 2019

(30) Foreign Application Priority Data
Sep. 1, 2016 (EP) 16186822.9

(51) Int. Cl. B32B 17/10; B32B 3/26

(52) U.S. Cl. CPC B32B 17/10568; B32B 3/263; B32B 17/10779; B32B 2605/00; B32B 17/10036; B32B 17/10174; B32B 2307/102; B32B 17/10541

(57) ABSTRACT

A composite pane for a head-up display, includes a first pane and a second pane that are joined to one another via a composite layer as well as a transparent, electrically conductive coating, wherein the composite layer has a first thermoplastic film, a polyester film, and a second thermoplastic film having a ratio of the thicknesses of the second thermoplastic film to the first thermoplastic film of 1.5:1 to 20:1.

The invention relates to a composite pane for a head-up display, a method for production of the composite pane, and use thereof.

Vehicles, in particular passenger cars, are increasingly equipped with so-called head-up displays (HUDs). Head-up-displays are provided for representing image information for an observer or driver. With a projector as an image encoder, for example, in the region of the dashboard or in the roof region, images are projected onto the windshield, reflected there, and perceived by the driver as a virtual image (from his point of view) behind the windshield. Thus, important information can be projected into the driver's field of vision, for example, the current driving speed, navigation or warning messages, which the driver can perceive without having to divert his glance from the road. Head-up displays can thus contribute significantly to an increase in traffic safety.

Usually, windshields comprise two glass panes that are laminated to one another via a thermoplastic film. If the surfaces of the glass panes are to be arranged at an angle, it is common to use a thermoplastic film with a non-constant thickness. This is also referred to as a wedge-shaped film or a wedge film. The angle between the two surfaces of the film is referred to as a wedge angle. The wedge angle can be constant over the entire film (linear change in thickness) or change as a function of position (nonlinear change in thickness).

With the above described head-up display, the problem arises that the projector image is reflected on both surfaces of the windshield. Thus, the driver perceives not only the desired primary image, which is caused by the reflection on the interior-side surface of the windshield (primary reflection). The driver also perceives a slightly offset secondary image, usually weaker in intensity, which is caused by the reflection on the exterior-side surface of the windshield (secondary reflection). This problem is commonly resolved in that the reflecting surfaces are arranged at an angle relative to one another deliberately selected such that the primary image and the secondary image (ghost image) coincide, as a result of which the secondary image (ghost image) is no longer distractingly noticeable.

It is also known to provide windshields with transparent, electrically conductive coatings. These coatings can act as IR reflecting coatings to reduce the heating up of the vehicle interior and thus to improve thermal comfort. The coatings can, however, also be used as heatable coatings by connecting them to a voltage source such that a current flows through the coating. Suitable coatings include conductive, metallic layers based on silver.

Windshields with conductive coatings in the interior of the composite glass have, in connection with head-up displays, the problem that the conductive coating forms an additional reflecting boundary surface for the projector image. This results in another undesirable secondary image, which is also referred to as a “layer reflection” or a layer “ghost”.

DE 10 2014 005 977 A1 discloses a HUD projection arrangement with a coated windshield. To avoid distracting images, it is proposed, in the case of a virtual image, to filter near infrared light components out of the imaging light beams. However, this solution has the disadvantage that the projector has to have additional infrared absorption elements in the beam path.

Known from DE 10 2012 219 950 A1 is a laminated pane arrangement that defines an outer glass plate defining an outer surface and an opposite first laminate surface; an inner glass plate defining an inner surface and an opposite second laminate surface; a first polyvinyl butyral (PVB) layer arranged adjacent the first laminate surface; a second PVB layer arranged adjacent the second laminate surface; and a polyethylene terephthalate (PET) layer arranged between the first PVB layer and the second PVB layer.

The outer edge of the PET layer and the outer edges of the PVB layers form a common outer edge such that the edge of the PET layer is not shielded against the environment. If the PET layer carries functional layers, for example, an electrically conductive coating, they are frequently susceptible to corrosion, greatly impairing the laminated pane arrangement in its function. Moreover, such PVB-PET-PVB layer arrangements often have a serious orange peel and internal defects. In this context, the person skilled in the art refers to an undesirably high surface roughness of the layer arrangement that is also visible in the finished end product and is generally perceived as distracting as “orange peel”. The person skilled in the art understands the term “internal defects” to mean a variety of further optically distracting defects and foreign body inclusions occurring in the laminate.

Such an orange peel becomes noticeable when the pane arrangement is used as a projection surface for a head-up display (HUD). In the context of HUDs, the problem arises that the orange peel greatly affects the quality of the virtual image. For the observer, the virtual image is no longer discernible as a sharp image. Instead, the virtual image is distorted by a wavy reflection of the electrically conductive coating and is largely displayed on recognizably.

The object of the invention is to provide a composite pane for a head-up display that minimizes interference caused by the surface roughness of the layer arrangement as much as possible.

The object of the present invention is accomplished according to the invention by a composite pane for a head-up display according to claim 1. Preferred embodiments are apparent from the dependent claims.

The composite pane according to the invention for a head-up display comprises at least a first pane and a second pane joined to one another via a composite layer as well as a transparent, electrically conductive coating, wherein the composite layer has a first thermoplastic film, a polyester film, and a second thermoplastic film having a ratio of the thicknesses of the second thermoplastic film to the first thermoplastic film of 1.5:1 to 20:1.

In other words, a composite pane for a head-up display is provided that has both two panes with a composite layer and the transparent, electrically conductive coating. In the composite pane according to the invention, wherein the virtual image generated by the head up display is presented particularly sharply, the first thermoplastic film has a thickness that is substantially lower than the thickness of the second thermoplastic film. The first thermoplastic film can be half as thick as the second thermoplastic film. The thickness of the first thermoplastic film can be only one tenth of the thickness of the second thermoplastic film. This has the advantage that, thus, the distance between the first pane and the polyester film is greatly reduced. As a result, the virtual image of the head-up display is more sharply displayed and its effect is qualitatively improved.

Advantageously, the first thermoplastic film and the polyester film can have a common edge that is at least partially spaced at a distance from an edge of the second thermoplastic film. In particular, the common edge can run parallel or substantially parallel to the edge of the second thermoplastic film. Such spacing prevents direct contact of the polyester film with the external environment of the composite pane.

The distance A can vary widely and can, consequently, be ideally adapted to the requirements of the individual case. Preferably, the distance A is between 1 mm and 400 mm, particularly preferably 5 mm to 250 mm.

In addition, the second thermoplastic film can fill the space between the edge, an inner side of the first pane, and the edge of the second thermoplastic film situated at a distance A from the edge and fuse with the material of the first thermoplastic film such that the edge is virtually completely isolated from the environment of the composite pane. By means of the isolation of the edge from the external environment of the composite pane, the internal defects occurring during the production process as well as surface roughness (“orange peel”) optically discernible after lamination are minimized.

The second thermoplastic film preferably has a wedge angle. The wedge angle (α) can be from 0.2 mrad to 1 mrad, preferably from 0.3 mrad to 0.7 mrad, particularly preferably from 0.4 mrad to 0.5 mrad. By means of the wedge angle, the shape of the composite pane is altered such that distracting reflections on the second pane can be largely compensated.

The second thermoplastic film can have properties for enhanced absorption of infrared and/or ultraviolet radiation. It can also be sound damping.

The thicknesses of the thermoplastic films and of the polyester film can vary widely and, consequently, be ideally adapted to the requirements of the individual case. Preferably, the first thermoplastic film is 20 μm to 200 μm thick, preferably 40 μm to 110 μm, in particular 40 μm to 60 μm, or 90 μm to 110 μm. Preferably, the polyester film is 10 μm to 130 μm thick, preferably 20 μm to 60 μm, in particular 40 μm to 60 μm. Preferably, the second thermoplastic film is 150 μm to 1000 μm thick, preferably 350 μm to 850 μm, and in particular 370 μm to 510 μm or 750 μm to 845 μm.

It has been surprisingly found that by means of a change in thickness of the first thermoplastic film, in particular a reduction, the virtual image generated by the head up display can be adjusted or changed. Preferably, with the thickness of the first thermoplastic layer of 40 μm to 110 μm, in particular approx. 50 μm, the visible distance between the reflection generated by a coating and the virtual image is significantly reduced. Thus, the undesirable reflection overlaps the virtual image and, in this manner, improves its quality.

The polyester film of the composite pane according to the invention has, at least partially on one surface, the transparent, electrically conductive coating. Preferably, the transparent, electrically conductive coating is applied on the polyester film by physical vapor deposition. The transparent, electrically conductive coating can be arranged between the at least one first thermoplastic film and the polyester film and/or between the polyester film and the second thermoplastic film. Preferably, the transparent, electrically conductive coating is directed toward the first thin thermoplastic film, in particular a PVB film, in order to avoid layer transfer during trimming. The transparent, electrically conductive coating has strong absorption in the infrared range of the light spectrum and thus prevents heating of the interior behind it. Alternatively, or additionally, the electrically conductive coating can be provided for heating the composite pane, for reflecting thermal radiation, and/or for transmitting and receiving radio radiation.

Preferably, the polyester film is a polyethylene terephthalate film (PET) or polybutylene terephthalate film, but preferably a polyethylene terephthalate film.

The first thermoplastic film and/or the second thermoplastic film can include a plastic, selected from the group consisting of polyvinyl butyral (PVB), ethylene vinyl acetate (EVA), polyurethane (PU), polypropylene (PP), polyacrylate, polyethylene (PE), polycarbonate (PC), polymethyl methacrylate (PMMA), polyvinyl chloride (PVC), polyacetate resin, casting resins, polyacrylates, fluorinated ethylene-propylene copolymers, polyvinyl fluoride, and/or ethylene-tetrafluoroethylene copolymers.

Particularly preferably, PVB is used. In particular, due to the low thickness, the first thermoplastic film can be implemented free of or substantially free of plasticizers.

Here and in the following, “substantially” means that the property or value in question can deviate from the exact value or property but not to an extent that the function in question that is defined by the value or the property is not disrupted or damaged.

The first and/or the second thermoplastic film can be colored, with the color and brightness freely selectable within broad limits. The second thermoplastic film can be UV radiation and/or IR radiation absorbent. Additional films, for example, switchable elements based on liquid crystals, suspended particles, or electrochromic layer structures can be used between the second thermoplastic film and the second pane.

In an advantageous embodiment, the composite pane according to the invention has a capacitive switching region, wherein the capacitive switching region is separated by at least one coating-free separating line out of the transparent, electrically conductive coating. The capacitive switching region is connected to a sensor electronic system via a connection region. The sensor electronic system is a capacitive sensor electronic system. The capacitive switching region is integrated into the composite pane according to the invention. That is particularly advantageous in terms of a thin design of the window pane as well as only slight interference with vision through the composite pane.

The composite pane according to the invention is preferably transparent, with the transmittance of the pane in the visible spectral range greater than 0%. Minimum legal requirements for transmittance in the visible spectral range apply for panes in the through-vision region of vehicle glazing. Here, for example, for windshields, transmittance of at least 70% is stipulated in the regulations ECE-R43, ANSI Z 26.1, and CCC/CNCA-04. A preferred embodiment of the invention is a windshield meeting this requirement.

The first pane and/or the second pane is/are constructed from a material that is constructed or consists of glass and/or at least a plastic, in particular a clear, rigid plastic.

Preferably, the glass is selected from the group consisting of flat glass, float glass, quartz glass, borosilicate glass, and soda lime glass.

Preferably, the clear, rigid plastic is selected from the group consisting of polyethylene, polypropylene, polycarbonate, polymethyl methacrylate, polystyrene, polyimide.

The thickness of the first pane and/or of the second pane can vary widely and thus be ideally adapted to the requirements of the individual case. Preferably, panes with standard thicknesses of 0.3 mm to 25 mm, preferably of 1.2 mm to 3.5 mm are used for vehicle glass.

The size of the first pane and/or of the second pane can also vary widely and is governed by the size of the composite pane according to the invention. For example, they can have the areas customary in the vehicle sector from 200 cm² all the way to 20 m².

The first pane and the second pane can have any outline. Thus, they can be triangular, rectangular, diamond-shaped, trapezoidal, pentagonal, or hexagonal, optionally with rounded corners, round, oval, elliptical, or kidney shaped, optionally with rounded edges.

The first pane and/or the second pane can have any three-dimensional shape. Preferably the three-dimensional shape has no shadow zones such that it can be coated, for example, by cathodic sputtering. Preferably, the panes are planar or slightly or greatly bent in one or a plurality of spatial directions. In particular, planar or substantially planar panes are used. The panes can be colorless or colored and/or include IR and/or UV radiation absorbing pigments. With the use of PET, a TSA outer pane can result in TTS increase (deterioration) (cf. DIN EN ISO 13837 Heat).

A development of the invention relates to a method for producing a composite pane, comprising the following steps
(a) Provision of at least one pane having a top side,
(b) Covering the top side with a thermoplastic film all the way to the edge region of the pane,
(c) Complete covering of the surface of the thermoplastic film opposite the top side with at least one polyester film,
(d) Complete covering of the free surface of the polyester film with at least one additional thermoplastic film,
(e) Vertical cutting of the polyester films and the additional thermoplastic film using a cutting device at a distance from the edge of the thermoplastic films,
(f) Removal of a film strip such that the additional thermoplastic films and the polyester film form a common edge and a free horizontal surface of the thermoplastic film is exposed, and
(g) Pressing on an additional pane using pressure, wherein an inner side of the additional pane makes contact with the top side of the additional thermoplastic film and and wherein a free space between the edge, the inner side, and the surface is filled by the influx of a material of at least one of the thermoplastic films.

The cutting of the first thermoplastic film and of the polyester film in step (e) is preferably done perpendicular to the surface of the first thermoplastic film.

In a preferred embodiment, the pressing on (g) is done at relatively high temperatures and under a vacuum. Suitable devices for this, such as vacuum bags, are common and known and need not be explained in detail here. Preferably, the lamination is done in an autoclave process.

The method according to the invention no longer has the disadvantages of the prior art, but, instead, surprisingly delivered, in a highly reproducible manner, composite panes that hardly have so-called “orange peel” or have none at all.

The composite pane according to the invention, in particular the composite pane according to the invention produced using the method according to the invention, can ideally be used as a movable and immovable functional and/or decorative single piece in furniture, appliances, and buildings as well as in means of transportation on land, in the air, or on water, such as aircraft, watercraft, trains, and motor vehicles, in particular, however, motor vehicles, for example, as a windshield, rear window, and side window and/or glass roof, in particular, however, as roof glazing.

Of course, the features mentioned above and explained in detail in the following can be used not only in the combinations and configurations indicated, but also in other combinations and configurations or in isolation without departing from the scope of the present invention.

The invention further includes the use of a composite pane according to the invention in a motor vehicle, preferably a passenger car, as a windshield that serves as a projection surface of a HUD display.

In the following, the invention is explained in detail with reference to drawings and exemplary embodiments. The drawings are schematic representations and are not true to scale. The drawings in no way restrict the invention.

They depict:

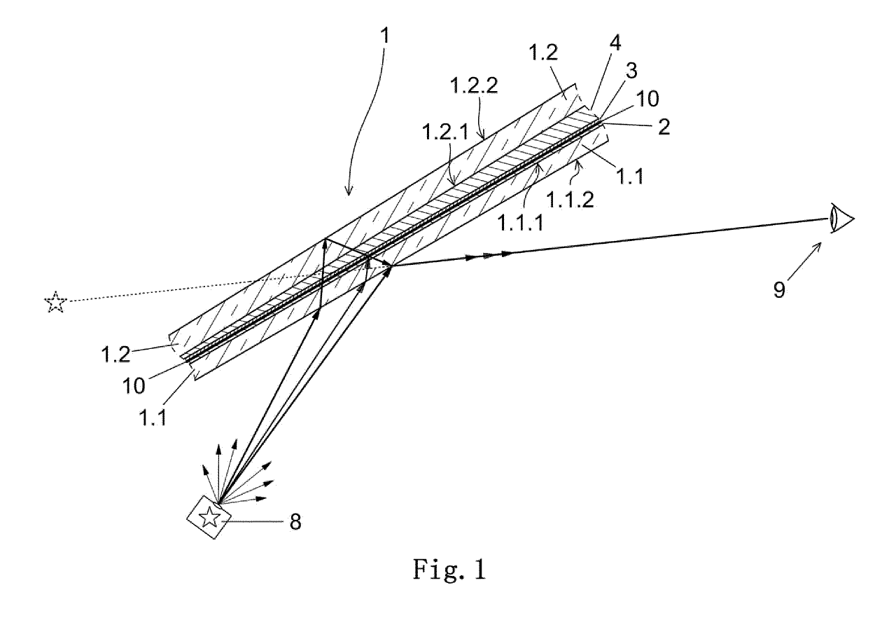

FIG. 1 a composite pane according to the invention as a component of a head up display,

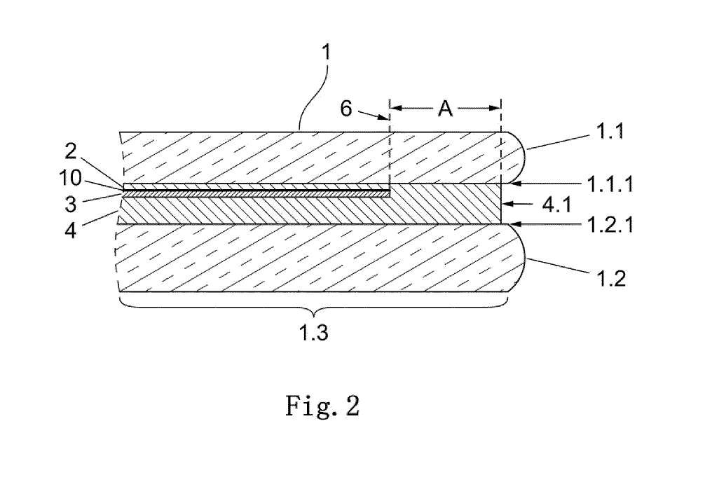

FIG. 2 a vertical longitudinal section through an edge region of the composite pane according to the invention,

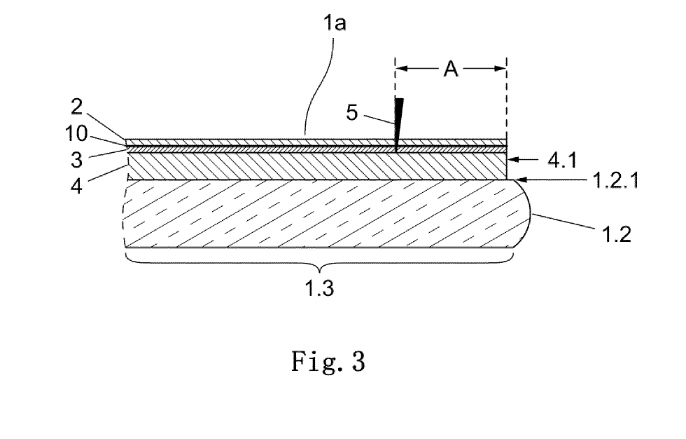

FIG. 3 a vertical longitudinal section through the edge region of an intermediate stage 1a during the production of the composite pane according to the invention,

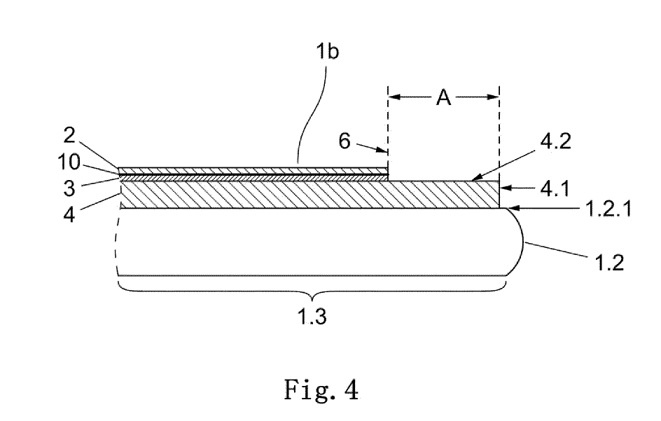

FIG. 4 a vertical longitudinal section through the edge region of the intermediate stage 1b during the production of the composite pane according to the invention,

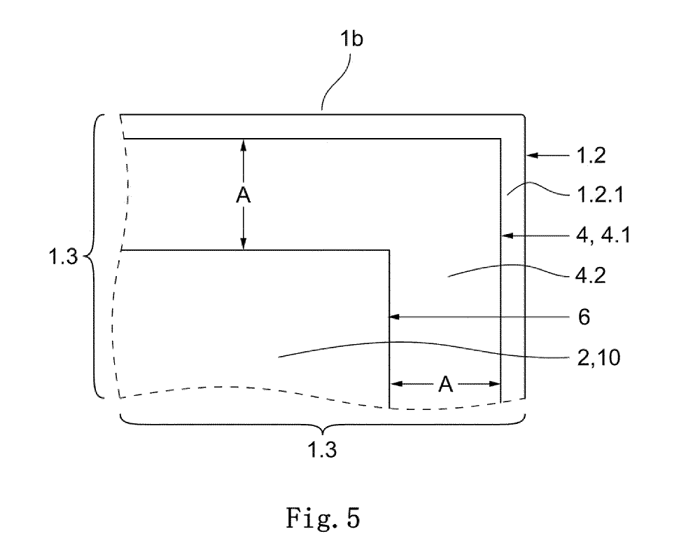

FIG. 5 a plan view of the intermediate stage 1b of the composite pane according to the invention, and

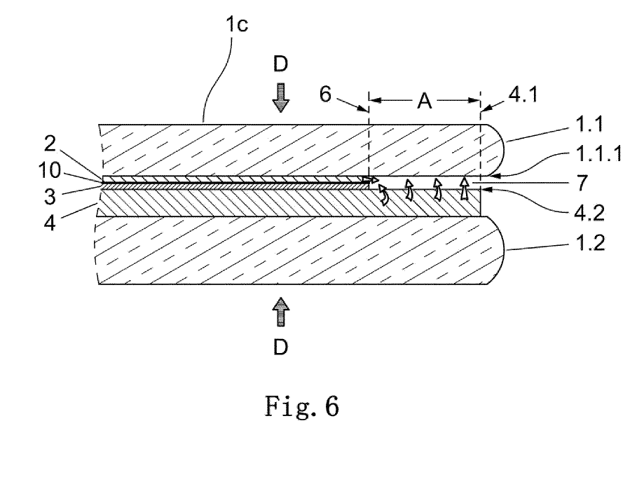

FIG. 6 a vertical longitudinal section through the edge region of the composite pane according to the invention during an intermediate stage 1c.

FIG. 1 depicts a composite pane 1 according to the invention as a component of a head-up display that comprises an inner pane 1.1 as a first pane, and an outer pane 1.2 as a second pane that are joined to one another via a multiple-ply composite layer 2, 3, 4. The composite pane 1 is provided as a windshield of a motor vehicle that is equipped with a head-up display (HUD). In the installed position, the outer pane 1.2 faces the external environment; the inner pane 1.1, the vehicle interior. The composite pane 1 has an upper edge that, in the installation position, is arranged upward toward the vehicle roof (roof edge) and a lower edge that is arranged downward toward the engine compartment (engine edge).

FIG. 1 further depicts a projector 4 as an image encoder of the HUD system, which is aimed at a subregion of the composite pane 1. In the subregion (HUD region), images can be produced by the projector 4, which are perceived by an observer (vehicle driver) as virtual images on the side of the composite pane 1 facing away from him. The non-reflected beam portion of the beam produced by the projector penetrates through the composite pane 1 and is reflected a second time (secondary reflection) on the outer side 1.2.2 of the outer pane 1.2. The wedge angle in the subregion of the composite pane 1 results in surfaces of the outer pane 1.2 and of the inner pane 1.1 inclined relative to one another and, thus, in superimposing of the primary reflection and the secondary reflection in one virtual image. Consequently, the primary reflection produced on the interior-side surface of the windshield and the secondary reflection produced on the outer-side surface of the windshield are no longer perceivable separately from one another.

The outer pane 1.2 has an outer-side surface 1.2.2, which, in the installed position, faces the external environment, and an interior-side top side 1.2.1, which, in the installed position, faces the interior. Likewise, the inner pane 1.1 has an inner side 1.1.1, which, in the installed position, faces the external environment, and an outer side 1.1.2, which, in the installed position, faces the interior of a vehicle. The interior-side top side 1.2.1 of the outer pane 1.2 is joined to the inner side 1.1.1 of the inner pane 1.1 via the composite layer 2, 3, 4.

The composite layer 2, 3, 4 consists at least of one first thermoplastic film 2, a polyester film 3, and a second thermoplastic film 4. The first thermoplastic film 2 has a thickness, that is substantially lower than the thickness of the second thermoplastic film 4. The thickness of the first thermoplastic film 2 is, by way of example, approx. 50 μm. The thickness of the second thermoplastic film 2 is at least 760 μm. The polyester film 3 is arranged between the first thermoplastic film and the second thermoplastic film 4. The polyester film 3 is approx. 50 μm thick and has, on its surface facing the first thermoplastic film 2, a transparent, electrically conductive coating 10.

The second thermoplastic film 4 is, here, in direct contact with the top side 1.2.1 of the outer pane 1.2. The second thermoplastic film 4, the polyester film 3, and the first thermoplastic film 2 are arranged congruently atop each other in the order indicated with increasing distance from the outer pane 1.2.

The thickness of the second thermoplastic film 4 increases continuously in the vertical course from the lower edge to the upper edge of the composite pane 1. In the figure, for the sake of simplicity, the increase in thickness is depicted as linear but can also have more complex profiles. The second thermoplastic film 4 is made of a single film of PVB (a so-called “variable-thickness wedge film”). The wedge angle α is between 0.25 mrad and 0.8 mrad, preferably between 0.35 mrad and 0.65 mrad. In HUD systems with a large image width, such as an augmented reality (AR) HUD system, even wedge angles of 0.1 mrad to 0.3 mrad are used. Referred to as AR HUD systems are HUD systems that operate with a computer-assisted extension of the perception of reality of a user.

For a wedge angle of 0.5 mrad and of the composite pane 1 with a height of 1 m, i.e., of an average height of a passenger car windshield, this is approx. 0.5 mm thickness change (e.g., 0.76 mm at the lower edge and 1.26 mm at the upper edge of the composite pane). A thickening of the film depends on the pane height as well as the wedge angle. With a preferred glass combination of inner pane/outer pane of 1.6 mm/2.1 mm, the total glass thickness would be 4.46 mm at the lower edge and 4.96 mm at the upper edge of the composite pane 1.

As a result of the wedge-shaped design of the second thermoplastic film 4, the two virtual images that are produced by reflections of the projector image on the outer side 1.2.2 of the outer pane 1.2 (secondary reflection) and the outer side 1.1.2 of the inner pane 1.1 (primary reflection), are superimposed. Consequently, the secondary reflection does not appear offset relative to the primary reflection such that distracting images can be avoided and, at the same time, the light yield and, thus, the image intensity is increased.

The composite pane 1 also has, on one surface of the polyester film 3, the transparent, electrically conductive coating 10. The transparent, electrically conductive coating 10 is IR reflective and is provided for the purpose of reducing heating up of the vehicle interior due to the IR component of sunlight. The transparent, electrically conductive coating 10 is, for example, a thin-film stack including 2 to 4 layers made of silver and other dielectric layers, which, as antireflection layers, blocking layers, or surface matching layers, optimize the optical, electrical, and/or mechanical properties of the coating. The dielectric layers of the transparent, electrically conductive coating 10 contain, for example, silicon nitride, silicon oxide, zinc oxide, tin zinc oxide, and aluminum nitride.

The transparent, electrically conductive coating 10 constitutes another reflecting boundary surface in the interior of the composite pane 1. Since the first thermoplastic film 2 is relatively thin compared to the second thermoplastic film 4, the distance from the transparent, electrical coating 10 to the outer side 1.1.2 of the inner pane 1.1 responsible for the primary reflection is also greatly reduced. Thus, the layer reflection overlays the primary reflection and the secondary reflection such that a sharp virtual image of the head-up display is created.

The inner pane 1.1 is made of soda lime glass and has only a low thickness of, for example, 1.6 mm. This ensures that the spatial offset between the primary reflection and the layer reflection is small, and the virtual images coincide such that a sharp, true-color correction image develops in the eye of the observer 5.

The composite pane 1 according to the invention was irradiated with a HUD projector 8 at an angle of incidence of 60° and the offset between the primary image and the reflection of the coating was determined at a typical eye position (position of the driver's eye). The image width of the HUD system was 2.3 m, as is typical for currently used HUDs. Measurements were carried out with various thicknesses of inner panes 1.1. The results are summarized in Table 1.

TABLE 1

| Thickness of inner pane 1.1/mm | 2.1 | 1.6 | 1.4 |
|---|---|---|---|
| Offset primary reflection − layer reflection/mm | 2.291 | 1.745 | 1.527 |

It can be seen that the offset becomes smaller with decreasing thickness of the inner pane 1.1. The inventors further found that, with a reduction in the distance between the outer side 1.1.2 of the inner pane 1.1 and the transparent, electrically conductive coating 10 of the polyester film 3, the reflection of the coating 10 is hardly noticed by an observer. The reflection of the coating can be positively influenced by the reduction in this distance. The virtual image of the head-up display is displayed particularly clearly. As a result of the relatively thin polyester film 3, which has a thickness of approx. 50 μm, the reflection on the coating 10 can be seriously affected; this was unexpected and surprising for the person skilled in the art.

The outer pane 1.2 is likewise made of soda lime glass and has a significantly greater thickness of, for example, 2.1 mm. This ensures that the composite pane 1 as a whole has sufficient mechanical stability, breaking resistance, and torsional stiffness.

The minimum thickness of the composite layer 2, 3, 4 is, for example, 0.48 mm (measured at the lower edge U). The second thermoplastic film 4 is implemented here by a single, wedge-shaped PVB film. However, a multiple-ply structure of the second thermoplastic film 4 is also conceivable, wherein at least one sub-film functions as a wedge film.

FIG. 2 depicts a vertical longitudinal section through an edge region 1.3 of the composite pane 1.

The composite pane 1 was formed by an inner pane 1.1 made of tempered float glass with a thickness of 2.1 mm. The edges of the inner pane 1.1 were rounded. The inner pane 1.1 had an inner side 1.1.1, which was associated with the multiple-ply composite layer 2, 3, 4.

In addition, the composite pane 1 was formed by an outer pane 1.2 of the same composition and dimensions. The outer pane 1.2 preferably has, in the region near the glass edge on the inner side 1.2.1, a black imprint to conceal the cutback. The inner pane 1.1 can, for example, for simpler specification of adhesive systems, also have a black imprint on side 1.1.2.

In addition, the outer pane 1.2 is frequently as much as 5 mm larger than the inner pane 1.1. The edges of the outer pane 1.2 were also rounded. The outer pane 1.2 had a top side 1.2.1, which was associated with the multiple-ply composite layer 2, 3, 4.

The inner side 1.1.1 of the inner pane 1.1 was in direct contact with a 50-μm-thick, plasticizer-free PVB film 2. This was underlaid with a 50-μm-thick PET film 3. The PVB film 2 and the PET film 3 had a common edge 6, that was situated at a distance A=1 cm from the edge 4.1 of the underlaid 760-μm-thick PVB film 4. The PVB film 4 lay on the the top side 1.2.1 of the outer pane 1.2. The material of the PVB film 4 completely filled the space between the edge 6 and the inner side 1.1.1 of the inner pane 1.1 to the distance A. Thus, the common edge 6 of the PVB film 2 and of the PET film 3 was completely isolated from the environment of the composite pane 1 such that the PET film 3 having the transparent, electrically conductive coating 10 had no corrosion damage. The composite layer 2, 3, 4 was, despite its lamination, no longer impaired in its function. Moreover, the PVB-PET-PVB composite layer 2, 3, 4 had no “orange peel” and no internal defects. In addition, it was possible to protect the PET film 3 during lamination due to the relatively thin second thermoplastic film 2. Furthermore, the separation of the first thermoplastic film 2 and the polyester film 3 from the second thermoplastic film 4 was quite successfully carried out during the production process. A cutback of the first thermoplastic film 2 and the polyester film 3 could be realized with no problems and thus resulted in no visible distractions. In particular, it was possible to avoid a layer transfer of the PET film 3 known to the person skilled in the art since the contacting PVB film 2 was removed at the same time.

FIG. 3 through 6 schematically depict production of the composite pane 1 referring to vertical longitudinal sections of the edge region 1.3. To illustrate the method, FIG. 5 shows the plan view of the intermediate stage 1b during the production of the composite pane 1. The materials and dimensions explained in detail with regard to FIG. 2 were used.

FIG. 3 illustrates the intermediate stage 1a of the production method according to the invention. The second thermoplastic (PVB) film 4 was laminated onto the top side 1.2.1 of the outer pane 1.2. Subsequently, the polyester (PET) film 3 and the first thermoplastic (PVB) film 2 where laminated onto the free top side of the second thermoplastic (PVB) film 4, such that the intermediate stage 1a resulted.

FIG. 4 illustrates the intermediate stage 1b of the production method. To produce the intermediate stage 1b, the intermediate stage 1a was cut with a diamond knife 5 (shown in FIG. 3) at the distance A from the edge 4.1 of the second thermoplastic (PVB) film 4 all the way to the surface of the second thermoplastic (PVB) film 4. The PVB-PET film piece cut off of the first thermoplastic film 2 and the polyester film 3 was removed, without the now exposed, free, horizontal surface 4.2 of the second thermoplastic (PVB) film 4 being damaged. The first thermoplastic (PVB) film 2 and the polyester (PET) film 3 now formed a common edge 6 spaced at a distance A from the edge 4.1 of the second thermoplastic (PVB) film 4.

This assembly is again illustrated with reference to FIG. 5.

FIG. 6 illustrates the intermediate stage lc. The inner pane 1.1 with the inner side 1.1.1 was placed on the assembly of the intermediate stage 1b according to FIGS. 4 and 5 such that they made contact with the first thermoplastic (PVB) film 2. Subsequently, the entire assembly was pressed together in heat and under vacuum with the pressure D in a vacuum bag. The hollow space between the common edge 6, the free surface 4.2, and the inner side 1.1.1 of the inner pane 1.1 was filled, in that the material of the second thermoplastic (PVB) film 4 flowed in the direction of flow 7 into the hollow space and fused with the material of the first thermoplastic (PVB) film 2. After cooling, release of the pressure D, and admission of air into the vacuum bag, the composite pane according to the invention 1 resulted.

### LIST OF REFERENCE CHARACTERS

1 composite pane
1a, 1b,
1c intermediate stages during production of the composite pane 1
1.1 inner pane of the composite pane 1
1.1.1 inner side of the inner pane 1.1
1.2 outer pane of the composite pane 1
1.2.1 top side of the outer pane 1.2
1.3 edge region of the composite pane 1
2 first (thin) thermoplastic film
3 polyester film
4 second (thick) thermoplastic (wedge) film
4.1 edge of the second thermoplastic film 4
4.2 free horizontal surface of the second thermoplastic film 4
5 cutting device
6 common edge of the first thermoplastic film 2 and of the polyester film 3
7 flow direction of the material of the thermoplastic film 4
8 projector
9 eye of the observer
10 transparent, electrically conductive coating
A distance of the common edge 6 from the edge 4.1 of the second thermoplastic film 4
D clamping pressure

1. A composite pane for a head-up display, comprising a first pane and a second pane that are joined to one another via a composite layer as well as a transparent, electrically conductive coating, wherein the composite layer has a first thermoplastic film, a polyester film, and a second thermoplastic film having a ratio of the thicknesses of the second thermoplastic film to the first thermoplastic film of 1.5:1 to 20:1.

2. The composite pane according to claim 1, wherein the first thermoplastic film and the polyester film have a common edge that is at least partially spaced at a distance from an edge of the second thermoplastic film.

3. The composite pane according to claim 1, wherein the second thermoplastic film has a wedge angle.

4. The composite pane according to claim 3, wherein the wedge angle is from 0.2 mrad to 1 mrad.

5. The composite pane according to claim 1 wherein the first thermoplastic film has a thickness of 40 μm to 110 μm.

6. The composite pane according to claim 1, wherein a projector for emitting an image is aimed at a region of the composite pane, and the composite pane is arranged to reflect the image, wherein a reflection of the image generated by the transparent, electrically conductive coating can be adjusted by a change in thickness of the first thermoplastic film.

7. The composite pane according to claim 1, wherein the second thermoplastic film is arranged to absorb infrared and/or ultraviolet radiation.

8. The composite pane according to claim 1, wherein the second thermoplastic film is implemented at least partially sound damping.

9. The composite pane according to claim 1, wherein the transparent, electrically conductive coating is arranged at least partially on a surface of the polyester film.

10. The composite pane according to claim 1, wherein the transparent, electrical coating is arranged to heat the composite pane, for reflecting thermal radiation, and/or for transmitting and receiving radio radiation.

11. The composite pane according to claim 1, wherein the polyester film is a polyethylene terephthalate film.

12. The composite pane according to claim 1, wherein the first thermoplastic film and/or the second thermoplastic film comprises a plastic selected from the group consisting of polyvinyl butyral, ethylene vinyl acetate, polyurethane, polypropylene, polyacrylate, polyethylene, polycarbonate, polymethyl methacrylate, polyvinyl chloride, polyacetate resin, casting resins, polyacrylates, fluorinated ethylene-propylene copolymers, polyvinyl fluoride, and ethylene-tetrafluoroethylene copolymers.

13. The composite pane according to claim 1, wherein the first thermoplastic film is free of or substantially free of plasticizers.

14. A method comprising arranging a composite pane according to claim 1 in a motor vehicle.

15. A method for producing a composite pane according to claim 1, comprising:
(a) providing at least one pane having a top side,
(b) covering the top side with a thermoplastic film all the way to an edge region of the pane,
(c) complete covering of a surface of the thermoplastic film opposite the top side with at least one polyester film,
(d) complete covering of the free surface of the polyester film with at least one additional thermoplastic film,
(e) vertical cutting of the polyester film and the additional thermoplastic film using a cutting device at a distance from the edge of the thermoplastic films,
(f) removing a film strip such that the additional thermoplastic film and the polyester film form a common edge and a free horizontal surface of the thermoplastic film is exposed, and
(g) pressing on of an additional pane using pressure, wherein an inner side of the additional pane makes contact with the top side of the additional thermoplastic film and wherein a free space between the edge, the inner side, and the surface is filled by the influx of a material of at least one of the thermoplastic films.

16. The composite pane according to claim 4, wherein the wedge angle is from 0.3 mrad to 0.7 mrad.

17. The composite pane according to claim 16, wherein the wedge angle is from 0.4 mrad to 0.5 mrad.

18. The composite pane according to claim 5, wherein the first thermoplastic film has a thickness of approximately 50 μm.

19. The composite pane according to claim 6, wherein the reflection of the image generated by the transparent, electrically conductive coating can be adjusted by a reduction in thickness of the first thermoplastic film.

20. The method according to claim 14, wherein the motor vehicle is a passenger car.
